(19) United States
(12) Patent Application Publication
(10) Pub. No.: US 2008/0025399 A1
(43) Pub. Date: Jan. 31, 2008

(54) METHOD AND DEVICE FOR IMAGE COMPRESSION, TELECOMMUNICATIONS SYSTEM COMPRISING SUCH A DEVICE AND PROGRAM IMPLEMENTING SUCH A METHOD

(75) Inventors: Fabrice Le Leannec, Mouaze (FR); Xavier Henocq, Melesse (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/778,917

(22) Filed: Jul. 17, 2007

(30) Foreign Application Priority Data
Jul. 26, 2006 (FR) 0653129

(51) Int. Cl. H04N 11/04

(52) U.S. Cl. 375/240.16

(57) ABSTRACT

The method of compressing images comprises, for at least one portion of an image to compress: a step of obtaining at least one parameter value representing the operation of at least one device for compressed image decompression; a step of selecting a quality level on the basis of at least one said parameter value; a step of estimating at least one motion vector between a portion of the image to compress and a portion of a reference image reconstructed at the selected quality level and a step of coding at least said image portion to compress by employing each estimated motion vector. In embodiments, during the obtaining step, a parameter represents a rate used and, during the selecting step, determination is made, from among a plurality of ranges of rate values, of the one in which is to be found the majority, at least relative, of the values of the rate used, and a quality level is selected that corresponds, in predetermined manner, to that range of values.

The present invention concerns a method and a device for image compression, a telecommunications system comprising such a device and a program implementing such a method. It applies, in particular, to the systems for video compression capable of providing different levels of quality, in the SNR (“Signal to Noise Ratio”) dimension.

The future emerging scalable compression system, SVC (“Scalable Video Coding”), which is an extension of the H264/AVC video compression standard, is in course of standardization. The objective of this new standard is to provide a scalable or hierarchical compressed representation of a digital video sequence. SVC provides support for scalability, or adaptability, along the following three axis: temporal, spatial and quality scalability.

Concerning quality scalability, this may take two different forms in the current SVC specification. More particularly, a quality refinement layer may be of CGS (“Coarse Grain Scalability”) type or else FGS (“Fine Grain Scalability”) type.

A refinement layer of CGS type contains, at the same time, refinement data, motion data and texture data. A CGS quality layer combines not only the motion compensated temporal prediction, but also the predictive coding of the motion and texture data from its base layer.

A refinement layer of FGS type contains progressive refinement data of the texture information. One or more successive FGS quality layers may be coded above the base layer or a spatial scalability layer or a CGS type layer. Typically, means for nested quantization and progressive coding of the DCT (“Discrete Cosine Transform”) coefficients makes it possible to provide a nested FGS bitstream, adapted to be truncated at any position and progressively increasing the quality of the entirety of the image considered.

In the technical contribution JVT-P059 presented at the JVT (“Joint Video Team”) meeting at Poznan, July 2005: “Comparison of MCTF and closed-loop hierarchical B pictures”, a comparison is shown of the coding efficiency obtained by applying the motion estimation in open loop, that is to say between original images of the sequence to code, and in closed loop, that is to say while using the reconstructed versions of the images at highest FGS level of rate as reference images. This contribution shows that the best performances are obtained using the motion estimation in closed loop.

The technical contribution JVT-P057 presented at the JVT (Joint Video Team) meeting at Poznan, July 2005: “Implementation of close-loop coding in JSVM” arrives at a similar conclusion.

However, the inventors have observed that the most important FGS quality layer for a user is not the maximum FGS quality layer but the layer that he actually receives after transmission. Thus, coding carried out with motion estimation taking, as reference, a reconstruction of the reference image from the maximum quality level, will not be optimum, in terms of the compression efficiency, if the user receives an SVC stream at an intermediate quality level lower that the maximum quality level.

The invention is thus directed to optimizing the coding efficiency for the quality level of FGS type that is the most important for the user, for example the quality level corresponding to the level, or interval, of rate the most requested by a set of clients at a given instant.

To that end, according to a first aspect, the present invention concerns a method of compressing a sequence of images, which comprises, for at least one portion of an image to compress:

a step of obtaining at least one parameter value representing the operation of at least one device for compressed image decompression;

a step of selecting a quality level on the basis of at least one said parameter value;

a step of estimating at least one motion vector between a portion of the image to compress and a portion of a reference image reconstructed at the selected quality level and

a step of coding at least said image portion to compress by employing each estimated motion vector.

Thus, the present invention enables a dynamic selection to be made of the quality level of the reference images according to the demand expressed by the users, in order to optimize the quality of the image rendered for the majority of those users.

Among other advantages of the present invention, it is observed that the use of this method of video compression within the coder, or within the associated device, does not necessitate modifying the decoding method and device.

According to particular features, during the step of obtaining at least one parameter value, a parameter for which at least one value is obtained represents a rate used for at least one transmission of compressed data to at least one compressed image decompression device.

Thus, the present invention enables a dynamic selection to be made of the quality level of the reference images according to the different levels of rate used by the users of the decompression devices, in order to optimize the quality of the image rendered for the majority of those users.

According to particular features, during the step of selecting a quality level, determination is made, from among a plurality of ranges of values of a predetermined parameter, of the one in which is to be found the majority, at least relative, of the values of said parameter used by compressed image decompression devices and selection is made of a quality level that corresponds, in predetermined manner, to said range of values.

According to particular features, during the step of obtaining at least one parameter value, at least one parameter for which at least one value is obtained represents a quality level implemented by a compressed image decompression device.

According to particular features, during the step of selecting a quality level, the quality level is selected which achieves a rate-distortion optimization of the choice of the motion vectors and of the reconstructed reference images used for the motion estimation.

According to particular features, each said image portion is a macroblock, the step of selecting the quality level being carried out individually for each macrohlock of at least one image of the sequence of images.

By virtue of these provisions, the optimization is carried out macroblock by macroblock, which improves the quality of the decompressed images.

According to particular features, during the coding step, SVC coding is carried out.

According to particular features, during the coding step, coding is carried out of a so-called “base” layer and of at least one quality layer of fine grain scalability, or FGS, type.

By virtue of each of these provisions, the present invention is applicable for optimizing the compression efficiency of the SVC coder, for the quality layers corresponding to the ranges of rates requested in the majority by the different “multicast” clients, that is to say who receive the same media.

For the user who receives an SVC stream at the selected intermediate quality layer, it will be possible for the coding to be more optimal at that quality level, in terms of the compression efficiency, since the motion estimation then takes as reference the version of the reference image which is actually reconstructed at the decoder of that user.

According to a second aspect, the present invention concerns a device for compressing a sequence of images, which comprises a means for obtaining at least one parameter value representing the operation of at least one compressed image decompression device and, for at least one portion of an image to compress:
a means for selecting a quality level on the basis of at least one said parameter value;
a means for estimating at least one motion vector between a portion of the image to compress and a portion of a reference image reconstructed at the selected quality level and
a means for coding at least said image portion to compress by employing each estimated motion vector.

According to particular features, the means for obtaining at least one parameter value is adapted such that a parameter for which it obtains at least one value represents a rate used for at least one transmission of compressed data to at least one compressed image decompression device.

According to particular features, the means for selecting a quality level is adapted to determine, from among a plurality of ranges of values of a predetermined parameter, the one in which is to be found the majority, at least relative, of the values of said parameter used by compressed image decompression devices and to select a quality level that corresponds, in predetermined manner, to said range of values.

According to particular features, the means for obtaining at least one parameter value is adapted such that at least one parameter for which it obtains at least one value represents a quality level implemented by a compressed image decompression device.

According to particular features, the means for selecting a quality level is adapted to select the quality level which achieves a rate-distortion optimization of the choice of the motion vectors and of the reconstructed reference images used for the motion estimation.

According to particular features, each said image portion is a macroblock, the selecting means being adapted to select a quality level individually for each macroblock of at least one image of the sequence of images.

According to particular features, the coding means is adapted to carry out SVC coding.

According to particular features, the coding means is adapted to carry out coding of a so-called “base” layer and of at least one quality layer of fine grain scalability, or FGS, type.

According to a third aspect, the present invention concerns a telecommunications system comprising a plurality of terminals devices connected via a telecommunications network, characterized in that it comprises at least one terminal device equipped with a compression device as succinctly set forth above and at least one terminal device equipped with a decompression device adapted to reconstruct images on the basis of the data issuing from said compression device.

According to a fourth aspect, the present invention concerns a computer program loadable into a computer system, said program containing instructions enabling the implementation of the compression method as succinctly set forth above, when that program is loaded and executed by a computer system.

As the advantages, objectives and particular features of this method compression, of this telecommunications system and of this computer program are similar to those of the compression device as succinctly set forth above, they are not repeated here.

Other advantages, objectives and features of the present invention will emerge from the following description, given, with an explanatory purpose that is in no way limiting, with respect to the accompanying drawings, in which:

FIG. 1 represents, in the form of a block diagram, a particular embodiment of an image compression device of the present invention;

FIG. 2 is a diagram of a multi-layer organization possible with SVC,

FIG. 3 illustrates the hierarchical SVC representation of FIG. 2, in which refinement layers of FGS type have been added,

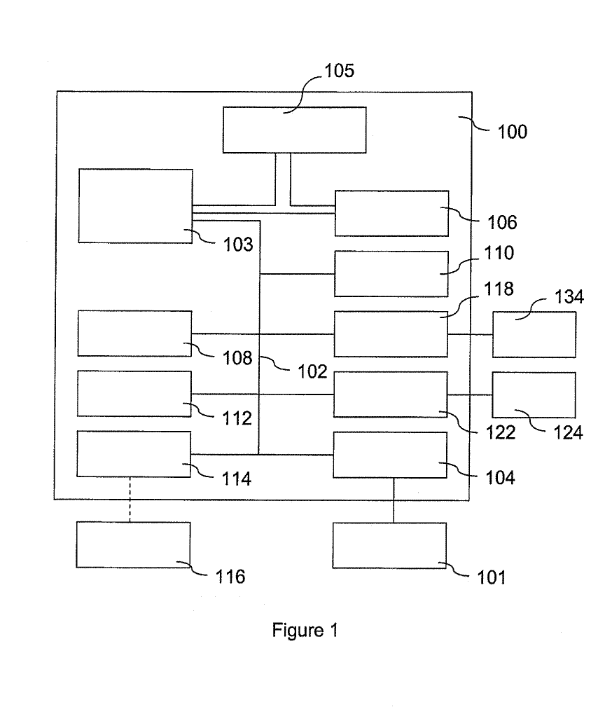

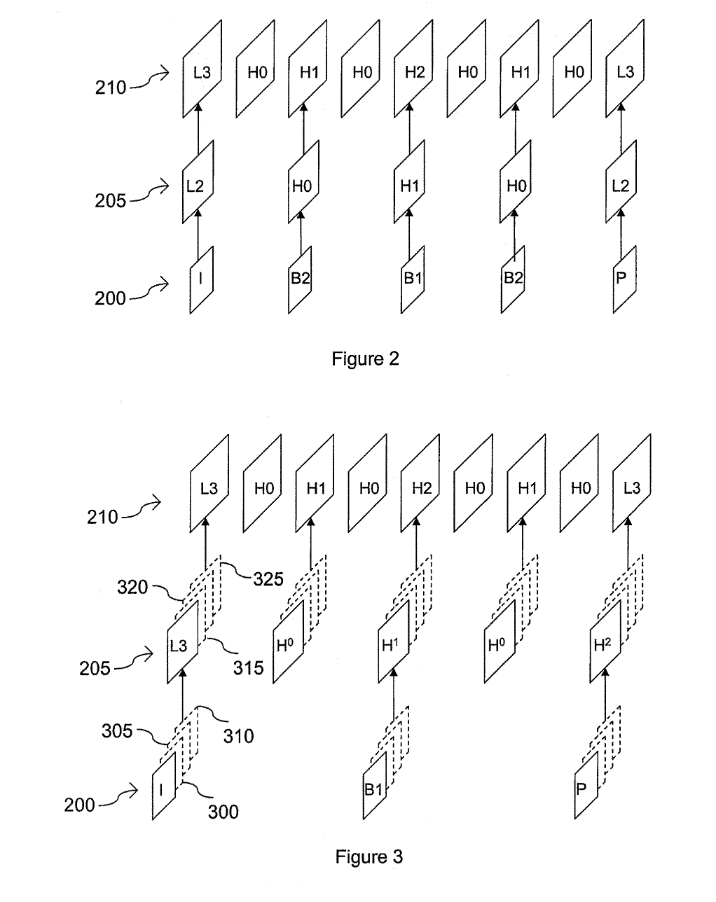

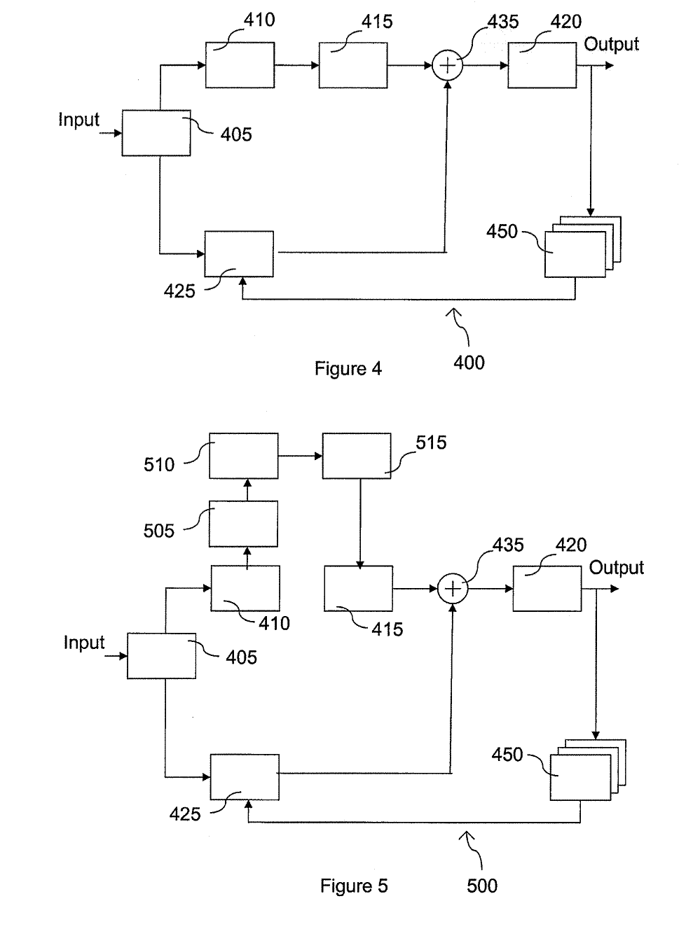

FIG. 4 is a diagram of a conventional video decoder, typically representative of the H264/AVC video compression standard,

FIG. 5 is a diagram of the insertion of the functions of decoding FGS refinement layers in the decoder illustrated in FIG. 4,

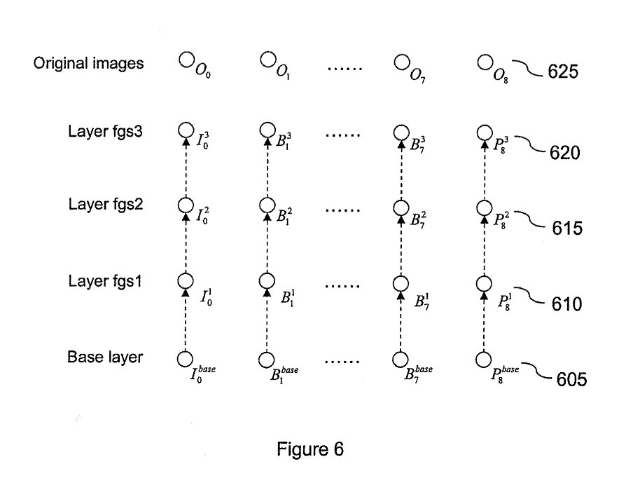

FIG. 6 is a diagram of the display quality levels linked to the coding and decoding of a sequence of images with incrementation of the quality level,

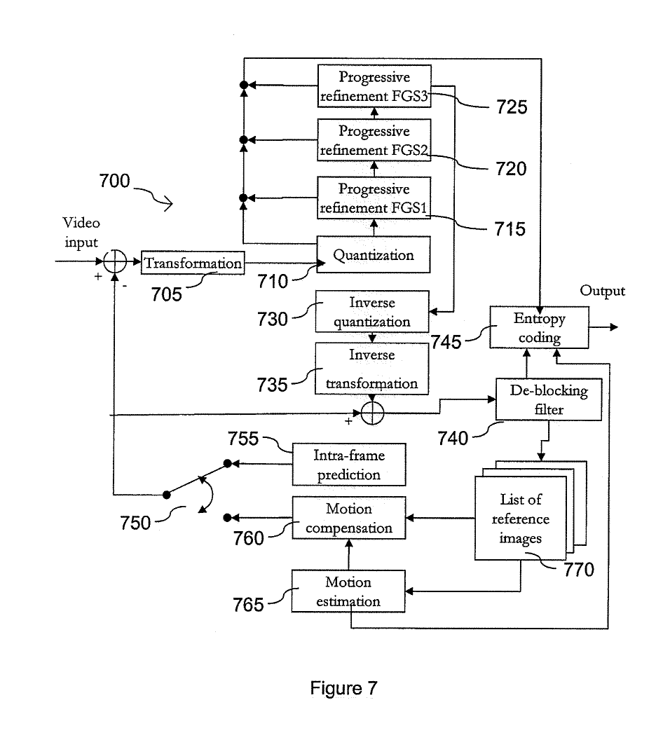

FIG. 7 represents, in the form of a block diagram, a coder of the prior art,

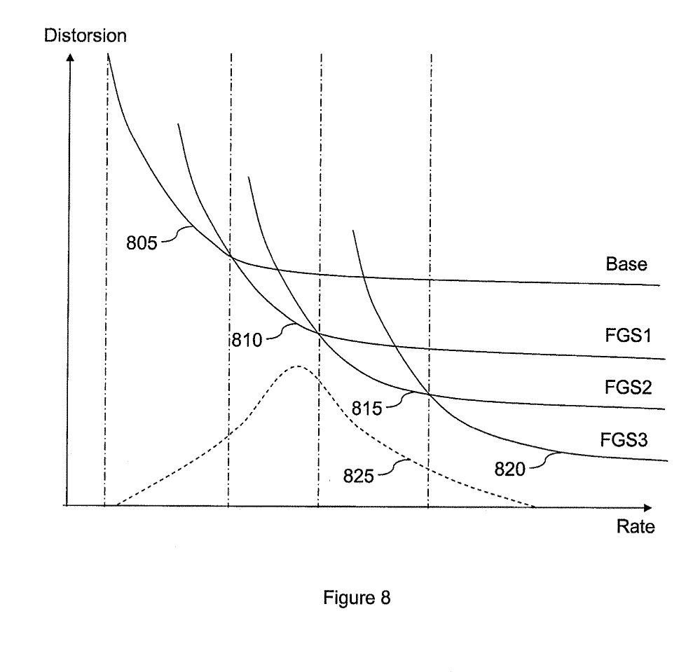

FIG. 8 represents qualities obtained after decoding, according to the quality level of the reference image used on coding,

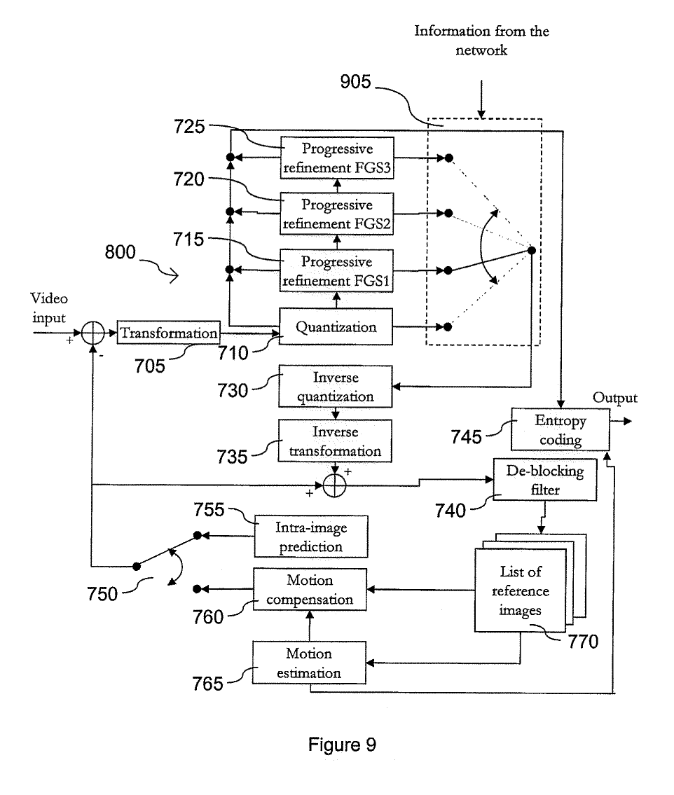

FIG. 9 represents, in the form of a block diagram, a particular embodiment of the coding device of the present invention;

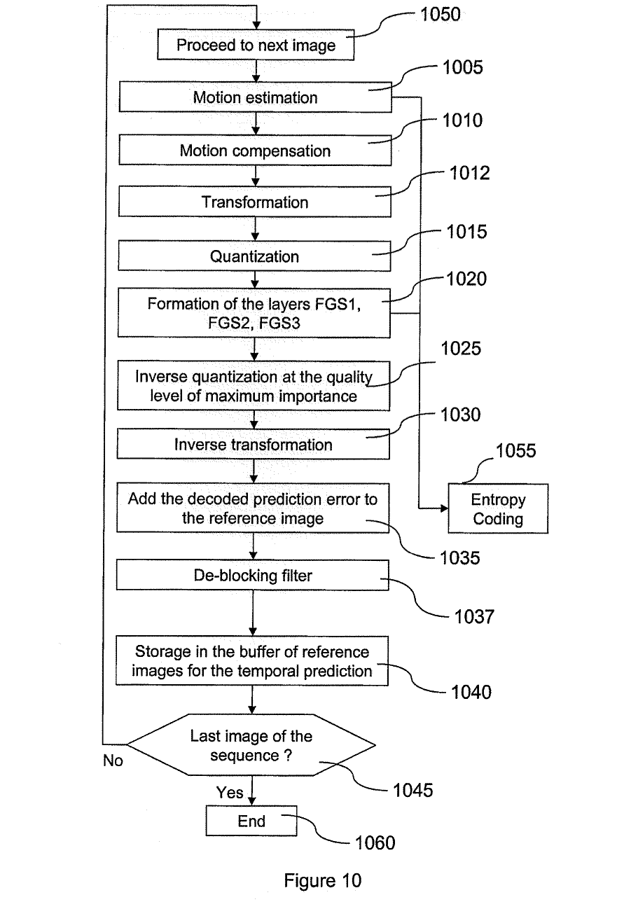

FIG. 10 is a representation, in the form of a logigram, of the steps implemented in a particular embodiment of the compression method of the present invention, and

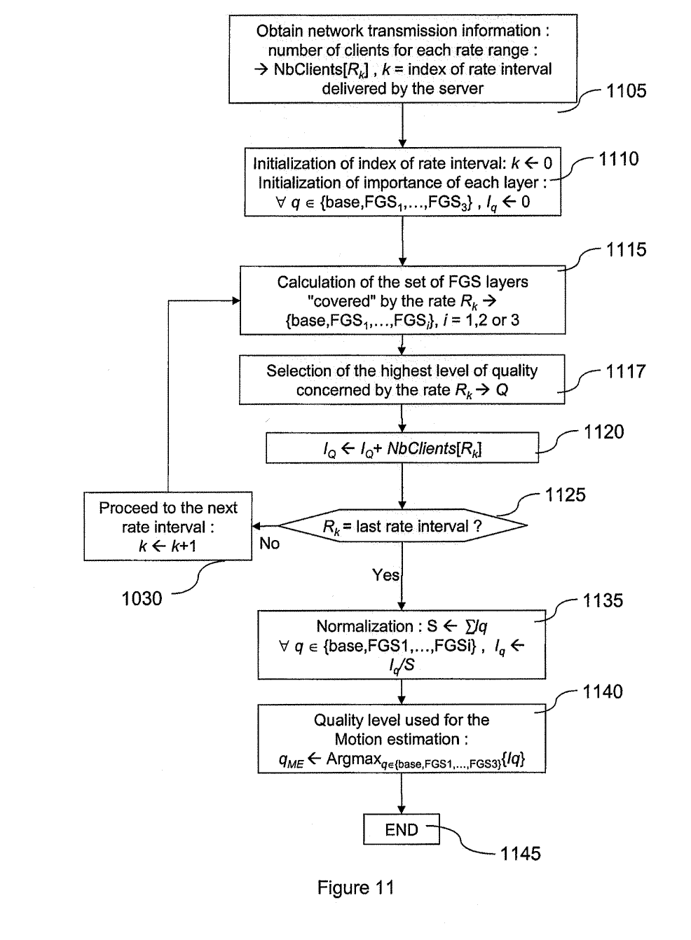

FIG. 11 is a representation in the form of a logigram of the steps implemented to perform one of the steps illustrated in FIG. 10.

Before describing the present invention, a reminder is given below, in relation to FIGS. 2 to 6, of the principles of the multi-layer representations of a video sequence with scalable video coding (SVC).

In the whole description, the terms “residue” and “prediction error” designate, in the same way, the same entity. Similarly, the terms “coding” and “compression” designate the same functions which apply to an image and the terms “decoding”, “reconstruction” and “decompression” are equivalent to each other.

Below, “base layer” will be used to designate the base layer compatible with the H264 standard, a spatial scalability layer or a CGS scalability layer.

The SVC video compression system provides hierarchies, or scalabilities, in the temporal, spatial and qualitative dimensions. The temporal scalability is obtained by the implementation of images of hierarchical B type in the base layer, or else, by virtue of MCTF (Motion Compensated Temporal Filtering), not described here, in the refinement layers. The quality or “SNR” scalability exists in two forms.

Coarse SNR scalability or “CGS” is provided by the coding of a layer in which either temporal decomposition into images of hierarchical B type, or motion compensated temporal filtering MCTF is carried out independently of the lower layer. A layer of coarse SNR scalability is predicted from the layer directly below.

Lastly, the spatial scalability is obtained by predictive coding of a layer in which motion compensated temporal filtering MCTF is performed independently of the lower layer. The coding of a spatial refinement layer is similar to that of a CGS layer, except that it serves to compress the sequence of video images at a higher resolution level than that of the lower layer. The coding includes, among others, a step of spatial upsampling in both spatial dimensions (width and height) in the inter layer prediction process.

The fine SNR scalability, or fine grain scalability, denoted “FGS”, is obtained by progressive quantization. The FGS layers coded as a refinement of a given layer only transport texture refinement information. They re-use the motion vectors transported by the base layer In the current implementation of reference of the SVC coder, this motion estimation is carried out either between the original image to compress and the reference images reconstructed at their highest FGS quality level (motion estimation in closed loop), or between the original images (motion estimation in open loop). Consequently, the estimation of the motion vectors, and thus the efficiency of coding, are found to be optimized for the maximum FGS quality level.

A progressive refinement of FGS type thus provides a refinement of the values of the texture samples representing a spatial or temporal prediction error. Note that no refinement of the motion information is transported by an FGS quality layer. The motion vectors associated with each temporally predicted macroblock are transported by the base layer above which the FGS layers are added. In other words, to reconstruct a temporally predicted macroblock, the motion vector used during the motion compensation by the decoder is unchanged whatever the quality level at which the decoder considered operates.

Consequently, the coder is responsible for generating a unique motion field which will then be used for the motion compensation in the base layer (base layer H264, spatial or CGS), as well as in all the FGS layers above that base layer.

FIG. 2 illustrates an example of multi-layer organization possible with the SVC compression system. The base layer 200 represents the sequence of images at its lowest spatial resolution level, compressed in a manner compatible with the H264/AVC standard. As illustrated in FIG. 2, the base layer 200 is composed of images of I, P and B hierarchical type.

The images of hierarchical B type constitute a means for generating a base layer that is scalable, that is to say adaptable, in the temporal dimension. They are denoted Bᵢ, i≧1, and follow the following rule: an image of type Bᵢ may be temporally predicted on the basis of the anchoring images, which are I or P type reference images which appear at the boundaries of the group of images processed (known as a Group of Pictures, denoted GOP), surrounding it, as well as the Bⱼ, j<i images, located in the same interval of I or P anchoring images. It is observed that between the anchoring images, images of B type are to be found. It is also observed that a B₁ image, that is to say the first image of a sequence, can only be predicted on the basis of the anchoring images surrounding it since there is no image Bj with j<i.

In the whole of the rest of the description, consideration is limited to the case in which the reference image is constituted by the preceding reconstructed image. However, on the basis of the following description, the person skilled in the art knows how to implement the present invention in other cases in which the reference image or images are different from the preceding reconstructed image, in particular if a plurality of reference images is used. The scope of the present invention is thus not limited to this last case. The present invention also covers the case of multiple lists of reference images used for the temporal prediction.

In FIG. 2, two spatial refinement layers, 205 and 210, are illustrated. The first spatial refinement layer 205 is coded predictively with respect to the base layer 200, and the second spatial refinement layer 210 is predicted from the first spatial refinement layer 205. A step of spatial oversampling which oversamples with a factor equal to two occurs during those inter layer predictions, such that a higher layer contains images of which the definitions are, in each dimension, double those of the layer immediately below.

FIG. 3 illustrates the hierarchical SVC representation of FIG. 2, in which refinement layers 300 to 325 of FGS type have been added, An FGS refinement layer consists of a quality refinement of the texture information. This texture information corresponds either to an error, or residue, of temporal prediction, or to an error, or residue, of spatial prediction, or to a texture coded in “Intra” without prediction. A scalability layer of FGS type provides a quality refinement of the texture information concerned, with respect to the layer below. This quality refinement is progressive, that is to say that the segment of bitstream arising from the FGS coding may be truncated at any point. The result of this truncation remains decodable and provides a representation of the whole image considered at a quality level which increases with the length of the decoded bitstream. The bitstream generated by the FGS coding is also said to be “progressive in quality” or “nested”.

These two worthwhile properties of FGS coding (quality refinement and progressiveness of the bitstream) are obtained by virtue of the following two coding tools:
progressive quantization: the quantization parameter attributed to a given FGS refinement layer is such that the quantization step size applied to the DCT coefficients is divided by two with respect to the layer below;
the cyclic coding of the DCT coefficients of the different blocks of an image: the order of coding of the DCT coefficients of an image is a function of the amplitude of the different DCT coefficients. The coefficients of greatest amplitude appear first in the bitstream. More particularly, a “significance pass” indicates coefficients that are significant with respect to an amplitude threshold. Next, an amplitude refinement pass makes it possible to code refinements of amplitude values of the coefficients already coded as significant. The macroblocks thus no longer appear in the bitstream in their natural scanning order, as in the coding of the other SVC layers. On the contrary, the DCT coefficients of the different blocks are interlaced and their order is a function of their respective amplitude. This cyclic coding, designated by the term “progressive refinement”, ensures the property of nesting of the FGS bitstream, that is to say the possibility of truncating it at any point, while leaving it to be capable of being decoded, each supplementary quality layer providing a quality increment spatially covering the whole of the image considered.

FIGS. 4 and 5 illustrate how the processing of the SVC refinement layers of FGS type is integrated within a video decoding algorithm. FIG. 4 illustrates a conventional video decoder 400, that is typically representative of the H264/AVC video compression standard, Such a decoder includes, in known manner, the application to each macroblock of the successive functions of entropy decoding, functional block 405, of inverse quantization, functional block 410, and of inverse transformation, functional block 415. The residual information arising from these first three operations is next added to a reference macroblock for its spatial or temporal prediction. The image resulting from this prediction finally passes through a deblocking filter 420 reducing the block effects. The image thus reconstructed is both adapted to be displayed, as well as to be stored in a list 450 of reference images. It is, more particularly, made to serve as reference image for the temporal prediction, functional block 425, for the next images to decode of the compressed bitstream, the image resulting from the temporal prediction 425 being added to the image arising from the inverse transformation 415 through an adder 435.

FIG. 5 illustrates the insertion of the functions of decoding of the FGS refinement layers in a decoder 500 comprising all the functions of the decoder 400 illustrated in FIG. 4. As illustrated in FIG. 5, the decoding of the progressive refinement layers of FGS type, functional blocks 505, 510 and 515, is located between the function of inverse quantization 410, and the function of inverse transformation 415, and is successively applied to all the macroblocks of the current image during decoding.

The FGS decoding provides, over the whole image, a refinement of the values of the samples after inverse quantization. Consequently, as illustrated in FIG. 5, the FGS decoding provides a progressive refinement of the spatial or temporal prediction error. This refined prediction error next passes via the same functions as in the decoder 400 of FIG. 4.

A progressive refinement of FGS type thus provides a refinement of the values of the texture samples representing a spatial or temporal prediction error. It is observed that no refinement of the motion information is transported by an FGS quality layer. The motion vectors associated with each temporally predicted macroblock are transported by the base layer above which the FGS layers are added. In other words, to reconstruct a temporally predicted macroblock, the motion vector used during the motion compensation by the decoder is unchanged whatever the quality level at which the decoder considered operates.

Consequently, the coder is responsible for generating a unique motion field which will then be used for the motion compensation in the base layer (base layer H264/AVC, spatial or CGS), as well as in all the FGS layers above that base layer.

FIG. 6 represents the interdependencies between the different FGS layers of the different images of the GOP (“Group Of Pictures”) given in an SVC video stream. FIG. 6 first of all illustrates a base layer 605, which represents an SVC layer of spatial scalability, CGS or the base layer compatible with H264/AVC. The images of this base layer are denoted I₀^{base}, Bₙ^{base} and Pₙ^{base}, in which the index n represents the index of the image, the exponent base indicates the layer to which the image belongs, and I, P or B represent the type of the image. Moreover, refinement layers FGS 610, 615 and 620, as well as the original images 625, are also illustrated in FIG. 6.

The images of the FGS layers are denoted Iₙⁱ, Bₙⁱ and PⁿI, in which notations the index n represents the index of the image, the exponent i indicates the FGS layer to which the image belongs, and I, P or B represent the type of the image.

During the process of temporal prediction of the macroblock of an image of P or B type, the coder performs a motion estimation. If the example is taken of the coding of the image P₈^{base} illustrated in FIG. 6, the motion estimation provides, for each macroblock of the image P₈^{base}, a motion vector linking it to a reference macroblock belonging to the image I₀³, i.e. the reference image reconstructed at the maximum quality level. This motion vector is next used in the motion compensation step in order to generate a prediction error macroblock, also termed residue or residual macroblock. This residual macroblock is next coded by quantization, transformation and entropy encoding. Furthermore, the image n is coded by refinement of the quantization applied to the residual macroblocks of the image P₈¹, before cyclic coding is carried out.

Several strategies may be employed by the coder for the motion estimation used, without however modifying the decoding algorithm. The following strategies have been explored by the SVC standardization committee:
the motion estimation in open loop consists of estimating, for each macroblock of an original image to code, a vector of motion between that macroblock and a macroblock of a reference image in its original version. The open loop motion estimation thus operates between original images of the sequence to be compressed;
the motion estimation in closed loop consists of estimating motion vectors between an original image and a reconstructed version of the reference image used. In the technical contributions to the SVC standardization committee, it is proposed to use the reference image reconstructed at the highest FGS quality level to perform the motion estimation in closed loop.

Studies show that better performances are obtained by performing the motion estimation in closed loop, between the original image to code and the reference image or images decoded at the highest FGS rate level. This is because working in closed loop makes it possible to take into account the distortions introduced during the quantization of the reference images.

It is furthermore to be noted that one of these contributions leads to the conclusion that the best compression performances are obtained by performing the motion compensation also in closed loop at the coder. The motion compensation in closed loop consists of calculating the temporal prediction error macroblocks by calculating the difference between an original macroblock to code and the reference macroblock reconstructed at the same FGS quality level. This configuration of the FGS coder leads to the best performances for all the FGS quality levels.

The present invention mainly concerns the process of motion estimation in closed loop. The inventors have noted that the motion estimation made by taking into account the reconstructed version of the original image in the highest FGS quality level leads to an optimization of the compression performance for the highest FGS quality layer. This is because, the motion estimation then takes into account the distortions introduced into the reference image on compression thereof. The fact of employing the reconstructed versions of the reference images at the highest FGS rate thus means that the coder takes into account the distortions introduced when all the FGS layers are decoded.

The present invention is directed to performing the motion estimation with respect to reference images reconstructed at intermediate levels to optimize the coding for these intermediate quality levels. The implementation of the present invention makes it possible to choose a quality level, from among the base and FGS quality levels, as level for reconstruction of the reference images for performing the motion estimation, in particular in closed loop.

In embodiments of the present invention, the choice of the level of quality used to the motion estimation is carried out according to a value of relative importance attributed to each of the quality levels that can be delivered by the coder. For example, in the embodiment given precedence by the invention, this value of importance is defined according to the proportion of the clients receiving, at each instant, each FGS quality layer during a multi-point video transmission.

Preferably, the dynamic choice of an FGS quality level for the reconstruction of reference images then used for estimating the motion vectors, on the basis of the relative importance of this FGS quality level in the transmission made.

It is noted that the fact of dynamically changing the quality level for the reconstruction of the reference images does not necessitate modifying the video decoding algorithm. The latter is unchanged, whatever the motion estimation strategy used at the coder end.

FIG. 1 shows a device or coder, 100, of the present invention, and different peripherals adapted to implement the present invention. In the embodiment illustrated in FIG. 1, the device 100 is a micro-computer of known type connected, through a graphics card 104, to a means for acquisition or storage of images 101, for example a digital moving image camera or a scanner, adapted to provide moving image images to compress.

The device 100 comprises a communication interface 118 connected to a network 134 able to transmit, as input, digital data to be compressed or, as output, data compressed by the device. The device 100 also comprises a storage means 112, for example a hard disk, and a drive 114 for a diskette 116. The diskette 116 and the storage means 112 may contain data to compress, compressed data and a computer program adapted to implement the method of the present invention.

According to a variant, the program enabling the device to implement the present invention is stored in ROM (read only memory) 106. In another variant, the program is received via the communication network 134 before being stored.

The device 100 is connected to a microphone 124 via an input/output card 122 which makes it possible to associate audio data with the data of images to code. This same device 100 has a screen 108 for viewing the data to be decompressed (in the case of the client) or for serving as an interface with the user for parameterizing certain operating modes of the device 100, using a keyboard 110 and/or a mouse for example.

A CPU (central processing unit) 103 executes the instructions of the computer program and of programs necessary for its operation, for example an operating system. On powering up of the device 100, the programs stored in a non-volatile memory, for example the read only memory 106, the hard disk 112 or the diskette 116, are transferred into a random access memory RAM 105, which will then contain the executable code of the program implementing the method of the present invention as well as registers for storing the variables necessary for its implementation.

Naturally, the diskette 116 may be replaced by any type of removable information carrier, such as a compact disc, memory card or key. More generally, an information storage means, which can be read by a computer or by a microprocessor, integrated or not into the device, and which may possibly be removable, stores a program implementing the coding method of the present invention. A communication bus 102 affords communication between the different elements included in the device 100 or connected to it. The representation, in FIG. 1, of the bus 102 is non-limiting and in particular the central processing unit 103 unit may communicate instructions to any element of the device 100, directly or by means of another element of the device 100.

By the execution of the program implementing the method of the present invention, the central processing unit 103 performs the functions illustrated in FIG. 9 and the steps illustrated in FIGS. 10 and 11 and constitutes the following means:
a means for obtaining at least one parameter value representing the operation of at least one device for compressed image decompression

and, for at least one portion of an image to compress, here each of the macroblock of images to compress:
a means for selecting a quality level on the basis of at least one said parameter value;
a means for estimating at least one motion vector between a portion of the image to compress and a portion of a reference image reconstructed at the selected quality level and
a means for coding at least said image portion to compress by employing each estimated motion vector.

In particular embodiments, the coding means is adapted to perform SVC coding with coding of quality layers of FGS type. In embodiments, the selecting means determines the relative importance of different levels of rate, by determining at what level of rate the majority of the users are at or by determining a median value or a mean of the levels of rate employed by the users, possibly by employing a weighted mean, each level of rate and/or each user having a relative weight, for example in relation to a difference in distortion between the implementations of different quality levels for reconstructing the reference images. As a variant, a cost function is implemented representing the loss in quality corresponding to a choice or another reconstructed image quality level to determine motion vectors and the minimum of this cost function is searched for, it being understood that it is possible for the users not all to have the same influence on the cost function used.

The functional diagram of FIG. 7 constitutes the counterpart, at the coder end, of the decoding algorithm illustrated in FIG. 5. A video coder 700 is seen in FIG. 7, generated FGS quality levels according to the state of the art. The video coder 700 comprises a video input supplying sequences of images to compress, a transformation function 705, a quantization function 710 and three FGS progressive refinement functions 715 to 725, respectively for the levels FGS1 to FGS3. The progressive refinement of the maximum quality texture data, issuing from the FGS3 725 progressive refinement function, is used by a function of inverse quantization 730, followed by a function of inverse transformation 735, to reconstruct a prediction or residual error image at the maximum quality level.

The progressive refinement of the texture data of maximum quality, issuing from the FGS3 725 progressive refinement function, is provided, firstly, to an entropy coder 745, which outputs the coded compressed images.

The reference image, coming from the switch 750 is summed with that reconstructed residual image and transmitted to a deblocking filter 740. The reconstructed image which results from this filter 740 constitutes the current image reconstructed in its final version, ready for display. This reconstructed image is furthermore stored in a list of reference images 770.

The reference image stored in the memory space 770 is employed by a motion estimation function 765 which determines, for each macroblock of the current image, a motion vector and supplies it not only the entropy coder 745 but also to a motion compensation function 760 which, moreover, uses the reference image coming from the memory 770.

The step of motion compensation 760 provides a reference macroblock for the temporal prediction of each macroblock of the current image. Furthermore, the intra-image prediction step 755 determines, for each block of the current macroblock in course of being processed, a reference block for its spatial prediction. The role of the switch 750 is then to choose the coding mode, from among temporal prediction, spatial prediction and INTRA coding, which provides the best compression performance for the current macroblock. This choice of mode optimized in terms of rate-distortion thus provides the reference macroblock used to predict each macroblock of the current image. A prediction image of the current image results therefrom. As indicated by FIG. 7, the difference between the current original image and that prediction image is calculated, and constitutes the prediction error image to code. This coding is effected by the steps of transformation, quantization and entropy coding mentioned earlier.

Thus, the video coder 700 generates a base layer and several FGS progressive refinement layers above that base layer. The block diagram of FIG. 7 typically illustrates a conventional video coder of H264/AVC type, in which functions of generating quality levels 715 to 725 of FGS type have been added. These FGS refinements progressively come to increase the quantization of the base layer, by dividing the quantization step size by two of a given FGS quality level with respect to the preceding quality level. The quantization indices of the transformed coefficients in the base layer, as well as the quantization refinement elements of the FGS layers are supplied to the entropy coder 745 that has the task of generating the compressed bitstream scalable in the SNR dimension.

In parallel, a reconstruction is carried out by the functions 730 to 740, to form a reference image which serves for the estimation and for the motion compensation performed by the functions 760 and 765.

FIG. 8 shows one advantage of the implementation of the present invention, in terms of compression performance. The different rate-distortion curves 805, 810, 815 and 820 can be seen in FIG. 8 which it can be envisaged to obtain when the motion estimation is carried out by successively using the different levels of FGS and base quality that can be delivered by the coder. On each of these curves, the lower the distortion, represented along the y-axis, the better the quality of the image. FIG. 8 illustrates the fact that taking the reconstructed images at a given quality level as references for the motion estimation leads to an optimization of the coding for the rate range corresponding to that quality level.

For example, choosing the maximum FGS quality level, here FGS3, for reconstructing the reference images serving for the motion estimation in closed loop corresponds to a rate distortion curve 820 below the other curves 805 to 815, that is to say to a reconstructed image of better quality, for the rate range precisely corresponding to that quality level, to the right in the Figure.

Furthermore, FIG. 8 shows a hypothetical histogram 825 of the different values of rate actually received by a set of clients in a multicast transmission tree, these values of rate being representative values of the operation of the client devices. It appears, in this example, that the most important rate range, that is to say the most “demanded” by the set of clients, corresponds to a rate range compatible with the second FGS level of quality, called FGS2.

By virtue of the implementation of certain embodiments of the present invention, the SVC coding is optimized for that quality level.

In other embodiments of the present invention, the SVC coding is optimized for the quality level corresponding to a minimum of a cost function representing the loss in quality that corresponds, for the set of users, to the choice of a level of reconstructed image quality to determine motion vectors.

It is noted that the principle of the invention also applies in the practical case of point to point video transmission, that is to say from a video server to a single client. In this case, the relevant or important rate range corresponds to the rate actually received by the single client. This bandwidth corresponds to a given quality layer of FGS type. In accordance with the present invention, the coding performance is optimized for this FGS quality level, and the motion estimation is thus carried out using, as reference images, images reconstructed precisely at that quality level used by the client.

Thus, in accordance with the present invention, the quality level for reconstruction of the reference images for the motion estimation is adapted on the basis of at least one value of at least one parameter representing the operation of at least one device for compressed image decompression, for example the values of the rates or of quality levels used on decompression.

A block diagram can be seen in FIG. 9 of a particular embodiment of an FGS coder 900 implementing the present invention. Like the video coder 700 illustrated in FIG. 7, the video coder 900 generates an H264/AVC compatible base layer, as well as progressive refinement layers of FGS type, on the basis of a selected quality level. The same functional blocks as in the coder illustrated in FIG. 7 are thus once again found in FIG. 9. However, to these functional blocks is added a mechanism 905 for adaptive choice of the FGS quality level at which are reconstructed the reference images which serve for the motion estimation in closed loop, on the basis of the quality level of maximum importance.

This mechanism 905, represented in the form of a switch transmitting the coefficients transformed and quantized into one of the four possible quality levels (base, FGS1, FGS2 or FGS3) to the inverse quantization function 730, takes into account information from the transmission network indicating the proportion of clients receiving each of the quality layers from among the base layer and the FGS refinement layers in the embodiment described here. Generally, the information from the network contains parameter values representing the operation of the client devices that are suitable for receiving and decompressing the compressed image.

For example, a mechanism for sending back information from the clients to the coder groups together the values of the rates received by the clients connected to said network. The video server associated with the coder 900 is furthermore capable of determining the ranges of rate corresponding to each of the quality levels delivered by the coder and transmitted to the clients. For example, by implementing the teaching of the document “Text of ISO/IEC 14496 Advanced Video Coding 3rd Edition” by G. Sullivan, T. Wiegand and A. Luthra, available from ISO/IEC/JTC 1/SC 29/WG 11, Redmond, Wash., USA, matching up is established between the lengths of the NAL (“Network Abstraction Layer”) units, or units for bitstream transfer, corresponding to each quality layer and the rates indicated by those messages sent back from the network. This mechanism is described further on, with regard to FIG. 11.

This matching up enables the coder to determine the proportion of clients each receiving available quality levels output by the coder and transmitted by the video server. This proportion of clients is used to define the relative importance of each quality layer generated by the video coder. This relative importance is used to make the choice of the base or FGS quality level for the reconstruction of reference images within the temporal prediction loop implemented by the inverse quantization and inverse transformation functions of the video compression. Thus, the coder 900 uses, as reference images, in its motion estimator 765, the images reconstructed and displayed by a majority, at least relative, of clients of the multicast application envisaged. This thus optimizes the video quality seen by that majority of clients.

FIG. 10 shows a logigram of the steps implemented in a particular embodiment of the method of the present invention, for performing the coding of a sequence of images, with a base layer and one or more progressive refinement layers above the base layer.

During a step 1005, an original image to compress is received, as well as information on relative importance of each quality level, calculated and supplied by the method illustrated in FIG. 11.

During the step 1005, for each macroblock of the current original image, a motion estimation is carried out after having searched, in a manner known per se, in a reference image, for a macroblock which resembles it the most in terms of a rate-distortion criterion. The macroblock so found serves as reference macroblock for the temporal prediction of the current original macroblock. The difference between the two macroblocks represents the prediction error signal, which is compressed via the steps of transformation 1012, quantization, step 1015, and entropy encoding, step 1055.

In order to form the FGS refinement layers, quantization step 1015 is followed by several successive quantizations with a quantization step size divided by two between two successive FGS quality levels, during a step 1020. The result of these successive quantizations is implemented during the entropy coding step 1055 to generate a bitstream representing the video sequence in compressed form.

Moreover, each prediction error macroblock thus compressed is then reconstructed. For this it first of all undergoes a step 1025 of inverse quantization. This inverse quantization is effected at the quality level of maximum relative importance furthermore determined by the method illustrated in logigram form in FIG. 11. During step 1025, an inverse quantization is thus progressively applied to the image until the quality level of maximum relative importance is reached. Next, the transformed coefficients obtained after inverse quantization, step 1025, undergone inverse transformation, step 1030. Each prediction error macroblock thus reconstructed is added to its reference macroblock, step 1035, to give a reconstructed macroblock. As these steps are applied to each macroblock of the image, the current image is thus completely reconstructed at the quality level of maximum importance. This reconstructed image is next submitted to a deblocking filter 1037, and is then stored in a list of reference images, during a step 1040.

During a step 1045, it is determined whether the processed image corresponds to the last image of the sequence of images to code. If yes, the method is made to terminate, step 1060. Otherwise, during a step 1050, the next image of the sequence of images to code is proceeded to, and step 1005 is returned to. The stored image reconstructed at the selected quality level serves as reference image for the motion estimation applied to the future images to code.

The reconstruction step detailed earlier is thus carried out such that the motion estimation for the next images of the sequence is carried out with reference to the images reconstructed at the most important quality level, for example the level received in the majority by the clients.

FIG. 11 represents, in logigram form, steps implemented for the selection of the quality level of maximum relative importance, from among the base layer and one of the layers of FGS type delivered by the video coder considered.

During a step 1105, information is obtained from the network, concerning the rates received by the set of the clients of the multicast transmission tree considered. In the particular embodiment described here, this information takes the form of a number of clients receiving a given rate. The set of the rates is quantized and reduced to a limited number of intervals of possible rates. The information sent back by the network is thus represented by a table of numbers of clients NbClients[Rk] for each rate of index k, which rate is denoted Rk, of the set of possible rates. It is to be noted that mechanisms exist for retrieving this information describing the conditions of reception of each client, and are not detailed here.

The following steps illustrated in FIG. 11, are directed at calculating the relative importance values for each level of quality q in the group {base, FGS1, FGS2, FGS3}. In the embodiment of the method of the present invention illustrated in FIGS. 10 and 11, the importance of each level of quality is defined as the proportion of clients who receive the level of quality considered. This importance is first of all initialized to 0 for each quality level during a step 1110. During a step 1115, for each rate Rk, with the quality levels (base or FGS) generated by the video coder and delivered by the video server, the quantity of information is calculated for each level of quality delivered by the server per unit of time, in a sliding temporal window. This quantity of information is calculated by summing the lengths of the NAL units (or unit of transfer of the SVC bitstream) emitted by the video server over the duration of the temporal window considered. These lengths of NAL units are known by the video server, since the NAL units are specifically generated and transmitted by that same video server. This quantity of calculated information provides a rated sent for each quality level. For a given rate Rk, determination is then made of the highest quality layer, starting from the base layer, concerned by that rate value, during a step 1117.
This is given by:

$$Q = {Arg min}_{q ∈ \{ base , {FGS}_{1} , {FGS}_{2} , {FGS}_{3} \}} \{ {\sum }_{q = base}^{{FGS}_{3}} length ( q ) \geq {R}_{k} \}$$

where length(q) represents the total length of the NAL units sent for the quality level q. In other words, the value of rate Rk received by certain clients concerns a certain number of levels of quality starting with the base level.

During a step 1120, for the maximum quality level concerned by the rate value Rk, the relative importance value is updated for that quality level. This updating takes the following form:
I_{Q}←I_{Q}+NbClients[Rₖ]

More particularly, the importance of the highest quality level Q concerned is increased the more clients there are that receive the rate Rk.

During a step 1125, it is determined if Rk is the last interval of rate to consider. If yes, step 1135 is proceeded to. Otherwise, during a step 1130, the next rate interval is proceeded to and step 1115 is returned to.

During the step 1135, each value of importance is normalized by dividing it by the sum of the calculated importance values. This makes it possible to have a relative importance value between 0 and 1 for each rate Rk. Lastly, the quality level of greatest relative importance is selected during a step 1140.

This most important level is next taken into account as from step 1025, illustrated in FIG. 10, for the reconstruction of the reference image.

The following portion of the description introduces another particular embodiment of the method of the present invention. The inputs of this embodiment consist of the different intervals of rates Rk received by the different multipoint clients. The most important interval of rate is then determined, that is to say that which corresponds to a rate received by a majority of clients. This rate of maximum importance is thus determined by the following simple expression.

$$R = {max}_{k} \{ {R}_{k} \} .$$

This value of rate R of maximum importance among the different rates received by the different clients is then taken into account in the algorithm for motion estimation contained in the process of temporal prediction of the video coder considered. In the particular embodiment described here, the process of motion estimation uses an algorithm for rate-distortion optimization, known to the person skilled in the art and included in the SVC software of reference, for estimating the motion vectors linking the blocks of the current image to code to their reference blocks.

Modification is thus made of the algorithm for rate distortion optimization put in place in the SVC software of reference, called JSVM (“Joint Scalable Video Model”), the object of which is to provide software of reference common to the members of the JVT committee to evaluate the performance of the compression tools proposed by the members of the committee. More particularly, for each sub-macroblock partition of a partition P of a macroblock of an image of type B to code, the motion estimation consists of searching for a reference block in a reference image which minimizes the following Lagrangian expression:

$${m}_{0 / 1} ( {r}_{0 / 1} ) = Arg {min}_{{m}_{0 / 1} ∈ S} \{ {D}_{SAD} ( {P}_{I} , {r}_{0 / 1} , {m}_{0 / 1} ) + {λ}_{SAD} ⌊ R ( {r}_{0 / 1} ) + R ( {m}_{0 / 1} ) ⌋ \} \qquad ( 1 )$$

where the distortion D_{SAD}, for a macroblock or sub-macroblock partition P, is given by the following expression:

$${D}_{SAD} ( P , {r}_{0 / 1} , {m}_{0 / 1} ) = {\sum }_{( i , j ) ∈ P} \vert {l}_{orig} [ i , j ] - {l}_{ref , 0 / 1} [ i + {m}_{0 / 1 , x} , j + {m}_{0 / 1 , y} ] \vert \qquad ( 2 )$$

In equation 2, I_{orig} represents the set of the samples of the original image in course of coding and I_{ref,0/1} represents the samples of the reference image used for the search for the best predictor of the current macroblock. The symbol 0/1 models the fact that the search is carried out successively on the lists indexed “0” and “1” of reference images, the list of index “0” containing the reference images in the pass (L₀), used for the forward prediction, and the list of index “1” containing future images, used for the backward prediction (L₁). In equation (1), S is the search space for the motion vectors. The terms R(r_{0/1}) and R(m_{0/1}) specify the cost (number of bits) linked to the coding of the indices r_{0/1} and of the components of the motion vector m_{0/1}.

Once the candidate motion vectors have been obtained for each sub-macroblock partition Pᵢ, i being the sub-macroblock partition index in the macroblock partition P, in each of the reference images of the lists L_{O} and L₁, selection is made of the reference images r₀ in R₀ and r₁ in R₁, and the associated motion vectors m₀ and m₁ which minimize the following Lagrangian expression:

$${r}_{0 / 1} = {Arg min}_{{{r}_{0 / 1} ∈ {R}_{0 / 1}}_{i ∈ L}} \{ {\sum }_{i ∈ P} ( {D}_{SAD} ( {P}_{i} , {r}_{0 / 1} , {m}_{0 / 1} ( {r}_{0 / 1} , i ) ) ) + {λ}_{SAD} ⨯ R ( {m}_{0 / 1} ( {r}_{0 / 1} , i ) ) + {λ}_{SAD} ⨯ R ( {r}_{0 / 1} ) \} \qquad ( 3 )$$

To introduce the concept of relative importance of each level of FGS quality in the selection mechanisms, the definition is modified of the measurement of distortion D_{SAD} as indicated by equation (4) below.

$${D}_{SAD} ( P , {r}_{0 / 1} , level , {m}_{0 / 1} ) = Importance ( level ) ⨯ {\sum }_{( i , j ) ∈ P} \vert {l}_{orig} [ i , j ] - {l}_{ref , 0 / 1. level} [ i + {m}_{0 / 1 , x} , j + {m}_{0 / 1 , y} ] \vert \qquad ( 4 )$$

where Importance(level) ε[0,1] represents the measurement of relative importance calculated by implementing the steps illustrated in FIG. 11. Importance(level) is measured for each quality level level in L=(base, fgsi, fgs2, fgs3). Consequently, I_{ref,0/1,level} represents the set of the samples of a candidate reference image reconstructed at the quality level level. Finally, the last step of selecting the reference image, in accordance with equation (3), is also modified. More particularly, it includes, in addition, selecting the quality level used at which is decoded the reference image used for the current macroblock partition P. This selecting step now takes the form of equation (5):

$$( {r}_{0 / 1} , level ) = {Arg min}_{{{r}_{0 / 1} ∈ {R}_{0 / 1}}_{I ∈ L}} \{ {\sum }_{i ∈ P} ( {D}_{SAD} ( {P}_{i} , {r}_{0 / 1} , level , {m}_{0 / 1} ( {r}_{0 / 1} , i ) ) ) + {λ}_{SAD} ⨯ R ( {m}_{0 / 1} ( {r}_{0 / 1} , i ) ) + {λ}_{SAD} ⨯ R ( {r}_{0 / 1} ) \} \qquad ( 5 )$$

Thus, a rate-distortion optimization of the choices of the motion vectors and of the reconstructed reference images used for the motion estimation in closed loop is made. This embodiment of the invention gives superior results to the preceding one, from the point of view of compression performance, in that the actual content of the reference images reconstructed at each of the levels of FGS quality is taken into account.

Furthermore, in this embodiment, the choice of the level of FGS quality of reference block for the motion estimation is carried out adaptively for each macroblock of the current image in course of compression.

Thus, the motion estimation process is carried out using as reference image or images one or more images reconstructed at the level of FGS quality selected on the basis of the practical conditions of transmission for example the bandwidth, in a given multipoint environment. The video quality received is optimized for a rate, or a quality level, required by a majority, at least relative, of clients.

Thus, the practical context of transmission of the scalable streams—typically the different values of bandwidths available in the multicast network considered—is taken into account for determining the relative importance of a layer of FGS quality from among a set of several layers of FGS quality delivered by the SVC coder.

The implementation of the present invention makes it possible to dynamically optimize the efficiency of compression of the SVC coder for the quality layers corresponding to the actual needs of the different multicast clients.

Thus, the present invention provides the functionality of progressive coding of the texture information and applies, in particular, to the case of the SVC system in course of standardization, but also to any coder having the capability of coding samples representing a signal in progressive and nested manner, or hierarchized manner, for example by use of nested quantization techniques and coding by bitplanes.

It is noted that the use of the method or of the device of the present invention, at the coder, does not necessitate modifying the decoding system or method.

1. A method of compressing a sequence of images, characterized in that it comprises, for at least one portion of an image to compress:
a step of obtaining at least one parameter value representing the operation of at least one device for compressed image decompression;
a step of selecting a quality level on the basis of at least one said parameter value;
a step of estimating at least one motion vector between a portion of the image to compress and a portion of a reference image reconstructed at the selected quality level and
a step of coding at least said image portion to compress by employing each estimated motion vector.

2. A method according to claim 1, characterized in that, during the step of obtaining at least one parameter value, a parameter for which at least one value is obtained represents a rate used for at least one transmission of compressed data to at least one compressed image decompression device.

3. A method according to any one of claims 1 or 2, characterized in that, during the step of selecting a quality level, determination is made, from among a plurality of ranges of values of a predetermined parameter, of the one in which is to be found the majority, at least relative, of the values of said parameter used by compressed image decompression devices and selection is made of a quality level that corresponds, in predetermined manner, to said range of values.

4. A method according to claims 1 or 2, characterized in that, during the step of obtaining at least one parameter value, at least one parameter for which at least one value is obtained represents a quality level implemented by a compressed image decompression device.

5. A method according to claims 1 or 2, characterized in that, during the step of selecting a quality level, the quality level is selected which achieves a rate-distortion optimization of the choice of the motion vectors and of the reconstructed reference images used for the motion estimation.

6. A method according to claims 1 or 2, characterized in that each said image portion is a macroblock, the step of selecting the quality level being carried out individually for each macroblock of at least one image of the sequence of images.

7. A method according to claims 1 or 2, characterized in that, during the coding step, SVC coding is carried out.

8. A method according to claim 7, characterized in that, during the coding step, coding is carried out of a so-called “base” layer and of at least one quality layer of fine grain scalability, or FGS, type.

9. A device for compressing a sequence of images characterized in that it comprises a means for obtaining at least one parameter value representing the operation of at least one compressed image decompression device and, for at least one portion of an image to compress:
a means for selecting a quality level on the basis of at least one said parameter value;
a means for estimating at least one motion vector between a portion of the image to compress and a portion of a reference image reconstructed at the selected quality level and
a means for coding at least said image portion to compress by employing each estimated motion vector.

10. A device according to claim 9, characterized in that the means for obtaining at least one parameter value is adapted such that a parameter for which it obtains at least one value represents a rate used for at least one transmission of compressed data to at least one compressed image decompression device.

11. A device according to any one of claims 9 or 10, characterized in that the means for selecting a quality level is adapted to determine, from among a plurality of ranges of values of a predetermined parameter, the one in which is to be found the majority, at least relative, of the values of said parameter used by compressed image decompression devices and to select a quality level that corresponds, in predetermined manner, to said range of values.

12. A device according to claims 9 or 10, characterized in that the means for obtaining at least one parameter value is adapted such that at least one parameter for which it obtains at least one value represents a quality level implemented by a compressed image decompression device.

13. A device according to claims 9 or 10 characterized in that the means for selecting a quality level is adapted to select the quality level which achieves a rate-distortion optimization of the choice of the motion vectors and of the reconstructed reference images used for the motion estimation.

14. A device according to claims 9 or 10, characterized in that each said image portion is a macroblock, the selecting means being adapted to select a quality level individually for each macroblock of at least one image of the sequence of images.

15. A device according to claims 9 or 10, characterized in that the coding means is adapted to carry out SVC coding.

16. A device according to claim 15, characterized in that the coding means is adapted to carry out coding of a so-called “base” layer and of at least one quality layer of fine grain scalability, or FGS, type.

17. A telecommunications system comprising a plurality of terminals devices connected via a telecommunications network, characterized in that it comprises at least one terminal device equipped with a compression device according to claims 9 or 10 and at least one terminal device equipped with a decompression device adapted to reconstruct images on the basis of the data issuing from said compression device.

18. A computer program that can be loaded into a computer system, said program containing instructions enabling the implementation of the method according to claims or 2, when that program is loaded and executed by a computer system.
